(19) United States
(12) Patent Application Publication
(10) Pub. No.: US 2007/0107193 A1
(43) Pub. Date: May 17, 2007

(54) Positioning device for moveable portion of workpiece

(76) Inventors: Dragoslav K. Milojevic, Bloomfield Hills, MI (US); Andreas Flaisch, West Bloomfield, MI (US)

Correspondence Address: HARNESS, DICKEY & PIERCE, P.L.C., P.O. BOX 828, BLOOMFIELD HILLS, MI, 48303, US

(21) Appl. No.: 11/262,381

(22) Filed: Oct. 28, 2005

(51) Int. Cl. B23Q 3/00

(52) U.S. Cl. 29/464; 29/559; 269/58

(57) ABSTRACT

A positioning device for a workpiece that has a body and a portion that is movably mounted to the body. The positioning device includes an abutment assembly having a first and second abutment member. The positioning device also includes an actuator assembly adapted for moving the abutment assembly between a locating position, in which the first abutment member is disposed adjacent the exterior surface of the portion of the workpiece while the second abutment member is disposed in the exterior space defined by the portion, and an inserted position, in which the second abutment member is disposed in the portion while the first abutment member is disposed in the exterior space defined by the portion. The actuator assembly is further adapted to move the portion relative to the body due to abutment between the portion of the workpiece and at least one of the first and second abutment members.

### FIELD OF THE INVENTION

The present invention relates to positioning devices, and more particularly relates to a positioning device for a moveable portion of a workpiece.

### BACKGROUND OF THE INVENTION

Robotic apparatuses are commonly employed in modern high-volume fabrication operations to perform repetitive tasks which would otherwise be tedious, fatiguing and/or difficult to perform manually in a cycle time of relatively short duration. One such task concerns the painting of a workpiece, such as an automotive vehicle, where high flow paint atomizers are frequently employed to coat the vehicle body with a film of liquid paint. The robust nature of a robotic apparatus permits the paint to be applied at relatively high flow rates, with or without high speed rotary atomization and with or without electrostatic charging of the paint material. In addition to applying paint to the vehicle, robotic apparatuses are often utilized to position movable portions of the vehicle. For example, vehicle doors are often pivoted relative to the vehicle body by robotic apparatuses to permit the doorjamb of the vehicle body to be painted or to permit components such as seats to be installed in the vehicle.

Although robotic apparatuses have worked for their intended purposes, some disadvantages remain. For instance, programmed movements of the robot may not adequately position the workpiece, especially if the workpiece is unexpectedly and/or improperly spaced in relation to the robot. In the case of a vehicle door, for instance, the robot might not be able to properly manipulate the door if the vehicle is closer to the robot than expected, thereby leading to extended production times, damage to the vehicle, and/or damage to the robot. Furthermore, many robotic end effectors of the prior art can exert excessive load on the workpiece and can damage the workpiece. In addition, many end effectors can deposit dirt, lubricant, or other undesirable substances on the workpiece.

Accordingly, there remains a need in the art for a device which allows a robot to properly position a workpiece despite unexpected spacing between the workpiece and the robot. There also remains a need for a positioning device that is unlikely to damage the workpiece during operation. In addition, there remains a need for a positioning device that is unlikely to deposit unwanted materials onto the workpiece during operation.

### SUMMARY OF THE INVENTION

Accordingly, the present invention is a positioning device for a workpiece that has a body and a portion that is movably mounted to the body, and wherein the portion has an exterior surface and also defines an exterior and interior space. The positioning device includes an abutment assembly having a first abutment member and a second abutment member. The positioning device also includes an actuator assembly adapted for moving the abutment assembly between a locating position, in which the first abutment member is disposed adjacent the exterior surface while the second abutment member is disposed in the exterior space defined by the portion of the workpiece, and an inserted position, in which the second abutment member is disposed in the interior space defined by the portion of the workpiece while the first abutment member is disposed in the exterior space defined by the portion of the workpiece. The actuator assembly is further adapted to move the portion relative to the body due to abutment between the portion of the workpiece and at least one of the first abutment member and the second abutment member.

In another aspect the present invention is a method of positioning a movably mounted portion of a workpiece relative to a body of the workpiece. The portion of the workpiece has an exterior surface, and the portion of the workpiece defines an exterior and an interior space. The method includes the step of locating an abutment assembly having a first abutment member and a second abutment member relative to the portion of the workpiece by moving the first abutment member adjacent to the exterior surface of the portion of the workpiece while the second abutment member is disposed in the exterior space defined by the portion of the workpiece. The method also includes the step of inserting the second abutment member into the interior space defined by the portion of the workpiece while the first abutment member is disposed in the exterior space defined by the portion of the workpiece. In addition the method includes the step of moving at least one of the first abutment member and the second abutment member into abutting contact with the portion of the workpiece to thereby move the portion relative to the body of the workpiece.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a front elevational view of one embodiment of a positioning device constructed according to the teachings of the present invention illustrated in operative association with a robotic apparatus and an automated fabrication system;

FIG. 2 is a perspective view of the positioning device of FIG. 1;

FIG. 3 is a sectional view of the positioning device of FIG. 1;

FIG. 4 is a side elevational view of another embodiment of the positioning device constructed according to the teachings of the present invention;

FIG. 5 a side view of the positioning device taken along the line 5-5 of FIG. 4;

FIG. 6 is a side view of another embodiment of the positioning device wherein the abutment assembly is disposed in a locating position; and

FIG. 7 is a side view of the positioning device of FIG. 6 wherein the abutment assembly is disposed in an inserted position.

### DETAILED DESCRIPTION OF THE PREFERRED EMBODIMENTS

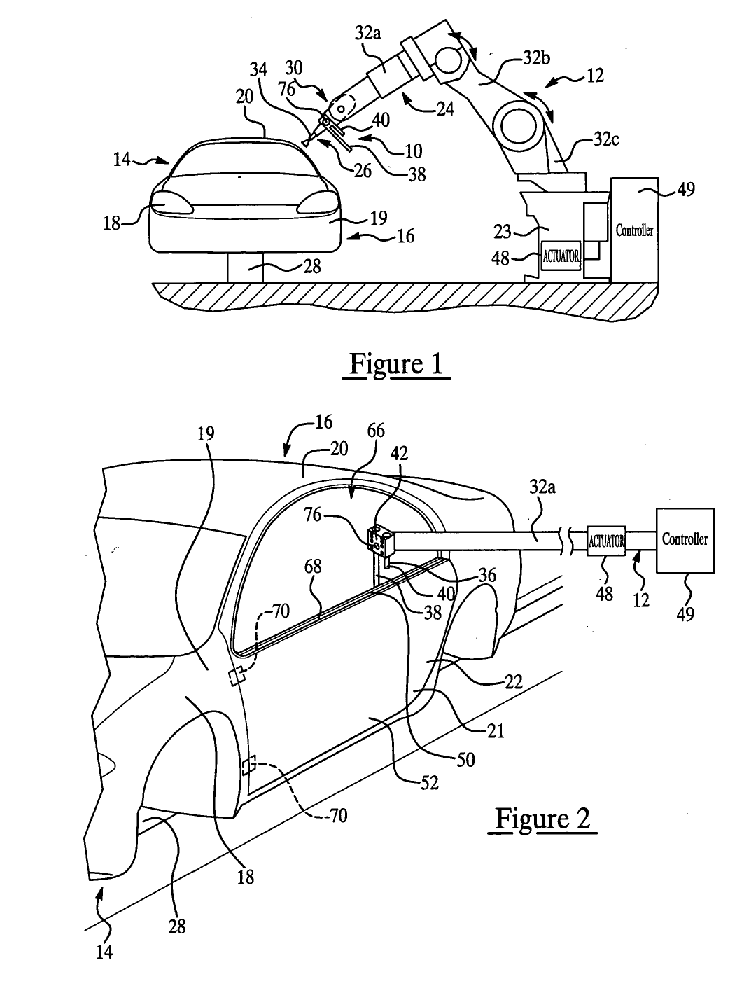

With reference to FIG. 1 of the drawings, a positioning device constructed in accordance with the teachings of a preferred embodiment of the present is generally indicated by reference numeral 10. Positioning device 10 is illustrated to be in operative association with a robotic apparatus 12, an automated fabrication system 14 and a workpiece 16, such as an automotive vehicle 18. The workpiece 16 includes a body 19, such as a vehicle body 20, and a movable portion 21 that is movably mounted to the body 19, such as a vehicle door 22 that is hingedly mounted to the vehicle body 20. As will be discussed in greater detail below, the positioning device 10 is operable to move the portion 21 relative to the body 19. It should be appreciated that the positioning device 10 could be used in relation to any suitable workpiece 16, and that the movable portion 21 could be movably mounted to the body 19 in any suitable fashion without departing from the scope of the invention.

In the embodiment shown, the automated fabrication system 14 includes a transfer line 28 which is operable for conveying the automotive vehicle 18 through one or more work stations to facilitate its fabrication. The robotic apparatus 12 is illustrated to include a base structure 23, an arm assembly 24 and an end effector 26. The base structure 23 is selectively pivotable about a generally vertical axis. The arm assembly 24 is coupled to base structure 23, and in the embodiment shown, the arm assembly 24 includes a wrist assembly 30 and a plurality of arm members 32 which pivotably couple wrist assembly 30 to base structure 23. The wrist assembly 30 is coupled to the distal end of the arm member 32a and permits the end effector 26 to be selectively rotated about the longitudinal axis of the arm member 32a. The end effector 26 is illustrated to include a plurality of spray nozzles 34 for applying a liquid material, such as paint, to the workpiece 16. It should be appreciated that the robotic apparatus 12 could be of any suitable type and could be operable to perform any suitable task other than painting operations without departing from the scope of the invention. In addition, although the embodiment of the positioning device 10 shown in FIG. 1 is supported by the robotic apparatus 12, the positioning device 10 could be independent of the robotic apparatus 12 without departing from the scope of the invention.

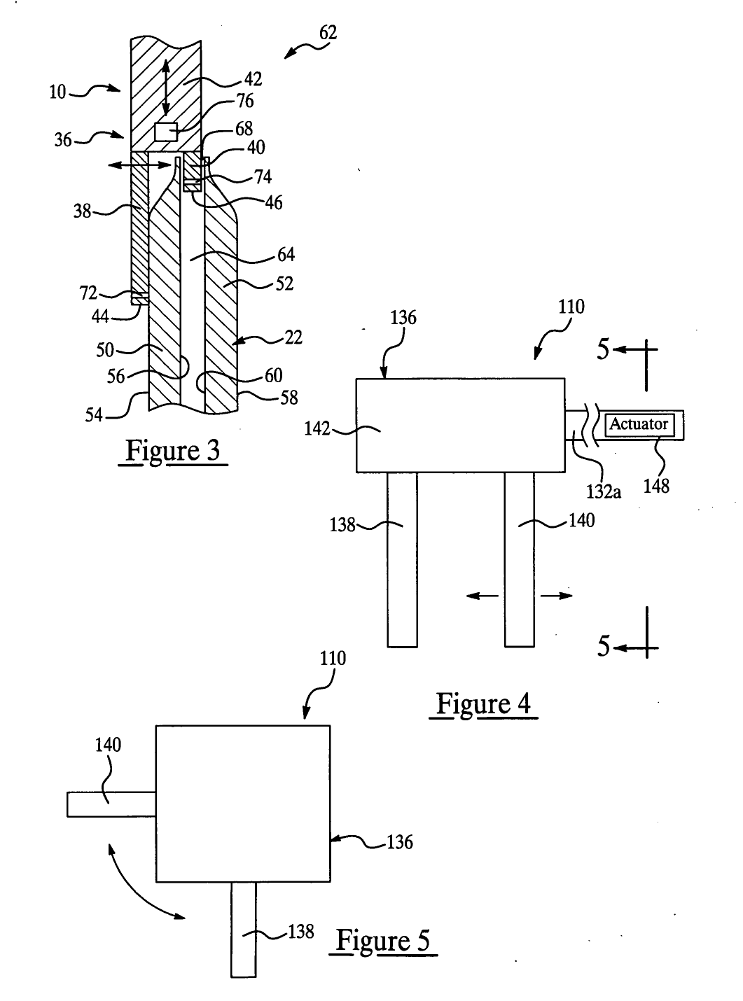

The positioning device 10 includes an abutment assembly 36, shown in FIG. 1 and shown schematically in FIGS. 2 and 3. The abutment assembly 36 includes a first abutment member 38, a second abutment member 40, and a mount member 42. In the embodiment shown, the first and second abutment members 38, 40 are rods that are axially straight and are each mounted to the mount member 42. For instance, in the embodiment shown, the first and second abutment members 38, 40 are mounted to the block-like mount member 42 in any suitable manner. In one embodiment, the first and second abutment members 38, 40 have similar widths (i.e., the diameter of each is the same). In another embodiment, the first and second abutment members 38, 40 have different widths.

In addition, the first abutment member 38 is axially longer than the second abutment member 40. More specifically, the first abutment member 38 includes a first terminal end 44, the second abutment member 40 includes a second terminal end 46, and the first and second abutment members 38, 40 are mounted such that the first terminal end 44 is disposed further away from the mount member 42 than the second terminal end 46. As will be discussed in greater detail below, the lengths of the first and second abutment members 38, 40 allow for proper positioning of the movable portion 21 of the workpiece 16.

The positioning device 10 also includes an actuator assembly 48. The actuator assembly 48 is adapted for moving the abutment assembly 36 relative to the body 19 of the workpiece 16. The actuator assembly 48 can be of any suitable type and can employ any number of suitable mechanisms for moving the abutment assembly 36. For instance, the actuator assembly 48 can include any number of pneumatic, hydraulic, electric, or any combination of actuator types for moving the abutment assembly 36. In one embodiment, the actuator assembly 48 moves the plurality of arm members 32 of the robotic apparatus 12 as described above, and in so doing, the actuator assembly 48 moves the abutment assembly 36. In another embodiment, the positioning device 10 includes a dedicated actuator assembly 48 that moves the abutment assembly 36 independent of the robotic apparatus 12. As will be discussed in greater detail below, the actuator assembly 48 moves the abutment assembly 36 such that at least one of the first and second abutment members 38, 40 abuts against the movable portion 21 of the workpiece 16 to thereby move the portion 21 relative to the body 19 of the workpiece 16 as will be discussed in greater detail.

The positioning device 10 also includes a controller, schematically illustrated at 49. The controller 49 is operable to transmit various control signals to the actuator assembly 48 to cause movement of the abutment assembly 36. The controller 49 can be of any suitable type. In one embodiment, the controller 49 also transmits control signals to the other components of the robotic apparatus 12 as well as the positioning device 10. In another embodiment, the positioning device 10 includes a dedicated controller that transmits control signals to the actuator assembly 48 independent of the robotic apparatus 12.

As stated above, the positioning device 10 can be used to move a vehicle door 22 relative to a vehicle body 20 during painting or other fabrication operations. In the embodiment illustrated in FIGS. 2 and 3, the vehicle door 22 has an inner panel 50 and an outer panel 52. The inner panel 50 has an exterior surface 54 and an interior surface 56, and the outer panel 52 likewise has an exterior surface 58 and an interior surface 60. The inner panel 50 and the outer panel 52 are joined such that the respective interior surfaces 56, 60 face each other and such that the respective interior surfaces 56, 60 are disposed in spaced relationship to each other. As such, the vehicle door 22 defines an exterior space, generally indicated at 62 in FIGS. 2 and 3, and an interior space 64 between the inner panel 50 and the outer panel 52. The inner and outer panels 50, 52 also include a window opening 66 and a window slot 68 that provides an opening into the interior space 64 of the door 22. A pane of window glass (not shown) can be included in the interior space 64 of the vehicle door 22 and can slide into and out of the interior space 64 via the window slot 68. The window can slide out of the interior space 64 to fill the window opening 66.

Furthermore, the vehicle door 22 is movably attached to the vehicle body 20 via a plurality of hinges 70 (FIG. 2). The vehicle door 22 is attached to the vehicle body 20 such that the inner panel 50 of the vehicle door 22 is closer to the vehicle body 20 than the outer panel 52. It should be appreciated that the vehicle door 22 could be movably attached to the vehicle body 20 in any suitable manner. For instance, in one embodiment, the vehicle door 22 is slidably attached to the vehicle body 20.

The actuator assembly 48 of the positioning device 10 is operable to move the abutment assembly 36 between a locating position (FIG. 2) and an inserted position (FIG. 3). In the locating position (FIG. 2), the first abutment member 38 is disposed adjacent the exterior surface 54 of the inner panel 50 of the vehicle door 22 while the second abutment member 40 is disposed in the exterior space 62. In the inserted position (FIG. 3), the second abutment member 40 is disposed in the interior space 64 defined by the vehicle door 22 while the first abutment member 38 is disposed in the exterior space 62 defined by the vehicle door 22. Once the abutment assembly 36 is in the inserted position (FIG. 3), the actuator assembly 48 moves the vehicle door 22 either toward or away from the vehicle body 20 due to abutment between the vehicle door 22 and at least one of the first and second abutment members 38, 40.

Thus, assuming that the vehicle door 22 is closed, and the vehicle door 22 is to be opened, the abutment assembly 36 is moved into the locating position shown in FIG. 2. More specifically, in the embodiment shown, the abutment assembly 36 moves into the vehicle body 20 through the window opening 66 and is then moved in an opposite direction away from the vehicle body 20 and toward the exterior surface 54 of the inner panel 50 of the vehicle door 22. As the abutment assembly 36 moves toward the exterior surface 54, the first abutment member 38 moves adjacent the exterior surface 54 to thereby “locate” the vehicle door 22. For instance, in the embodiment shown, the positioning device 10 includes at least one first sensor 72 mounted to the first abutment member 38, and the first sensor 72 “locates” the vehicle door 22 by detecting the distance between the exterior surface 54 of the door 22 and the first abutment member 38. In one embodiment, the first sensor 72 is a contact sensor adapted for detecting abutment between the exterior surface 54 and the first abutment member 38, and when abutment occurs, the first sensor 72 detects a “zero distance” condition between the exterior surface 54 and the first abutment member 38. In another embodiment, the first sensor 72 is a proximity sensor that detects distances greater than zero between the exterior surface 54 and the first abutment member 38 in order to locate the vehicle door 22. When the first sensor 72 detects the distance between the exterior surface 54 and the first abutment member 38, the first sensor 72 transmits a correlative signal to the controller 49. The positioning device 10 could include any suitable circuitry and programming, such as a feedback loop, to locate the vehicle door 22.

It should be appreciated that the lengths of the first and second abutment members 38, 40 can be designed for efficient movement of the abutment assembly 36 while locating the vehicle door 22. More specifically, in the embodiment shown, the first abutment member 38 is longer than the second abutment member 40 such that the abutment assembly 36 can be moved in a horizontal plane toward the exterior surface 54 of the door 22 without creating contact between the second abutment member 40 and the vehicle door 22. Thus, in one embodiment, the abutment assembly 36 is moved into the vehicle body 20 through the window opening 66, then the abutment assembly 36 is moved downward, and then the abutment assembly 36 is moved in a horizontal plane until the first abutment member 38 abuts against the exterior surface 54 and the first sensor 72 detects the abutment. At this point, the vehicle door 22 has been located.

It should be appreciated that on an assembly line, the position of the vehicle 18 with respect to the positioning device 10 may vary between vehicles 18 arriving at the robotic apparatus 12. The process of locating the vehicle door 22 described above accommodates for any variations in the position of the vehicle door 22 with respect to the positioning device 10. As such, the vehicle 18 can be fabricated and completed more quickly and efficiently.

Once the vehicle door 22 has been located, the abutment assembly 36 is moved into the inserted position shown in FIG. 3. For instance, in the embodiment shown, the abutment assembly 36 is moved vertically downward, causing the second abutment member 40 to move through the window slot 68 into the interior space 64 of the vehicle door 22. In one embodiment, the second abutment member 40 is spaced away from the first abutment member 38 according to the dimensions of the particular vehicle door 22 such that the abutment assembly 36 can move from the locating position (FIG. 2) to the inserted position (FIG. 3) in a single vertical movement. It should be appreciated that the second abutment member 40 could be inserted into the vehicle door 22 through any suitable opening other than the window slot 68 without departing from the scope of the invention.

In the embodiment shown, the positioning device 10 includes at least one second sensor 74 mounted to the second abutment member 40 to thereby detect distance between the second abutment member 40 and at least one of the inner and outer panels 50, 52 of the vehicle door 22. The second sensor 74 can of any suitable type, such as a contact sensor or a proximity sensor to detect proper insertion of the second abutment member 40 into the vehicle door 22. It should be appreciated, however, that the second abutment member 40 could be inserted into the vehicle door 22 according to the known dimensions of the vehicle door 22 without detecting distance between the second abutment member 40 and the vehicle door 22.

Once in the inserted position, the abutment assembly 36 is moved away from the vehicle body 20 to thereby pivot the vehicle door 22 about the hinges 70 away from the vehicle body 20. More specifically, as the abutment assembly 36 moves away from the vehicle body 20, abutment occurs between the vehicle door 22 and at least one of the first abutment member 38 and the second abutment member 40. Further movement of the abutment assembly 36 away from the vehicle body 20 causes the vehicle door 22 to open away from the vehicle body. To open the door 22, the abutment assembly 36 could be moved in any suitable direction away from the vehicle body 20. For instance, the abutment assembly 36 can be moved linearly, rotationally, or in a combination of both types of movements.

In one embodiment, the abutment assembly 36 remains in the inserted position (FIG. 3) to hold the door 22 open while additional processing of the vehicle 18 occurs. To close the vehicle door 22 in such a case, the abutment assembly 36 is moved toward the vehicle body 20 to cause abutment between the vehicle door 22 and at least one of the first and second abutment members 38, 40.

In another embodiment, structures other than the abutment assembly 36 (e.g., the hinges 70, a prop bar, or other separate structures) hold the door 22 open while additional processing of the vehicle 18 occurs. Before this additional processing occurs, the abutment assembly 36 is moved away from the vehicle 18. To move the abutment assembly 36 away from the inserted position (FIG. 3) and away from the vehicle 18, the abutment assembly 36 is moved vertically such that the second abutment member 40 moves out of the vehicle door 22 through the window slot 68, and the abutment assembly 36 is moved away from the vehicle 18 through the window opening 66. Then, to close the vehicle door 22, the abutment assembly 36 is moved through the window opening 66, and the abutment assembly 36 is moved into the locating position (FIG. 2) as described above. Next, the abutment assembly 36 is moved into the inserted position (FIG. 3) as described above. Finally, the abutment assembly 36 is moved toward the vehicle body 20 to cause abutment between the vehicle door 22 and at least one of the first and second abutment members 38, 40 to thereby close the vehicle door.

In the embodiment shown, the positioning device 10 also includes at least one load sensor 76 (shown schematically) that is operable to detect a load on the abutment assembly 36. The load sensor 76 can be of any suitable type, such as a strain gauge, and can be used to monitor the loading of the abutment assembly 36. In one embodiment, the controller 49 utilizes the load sensor 76 to detect if the loads on the abutment assembly 36 exceed a predetermined level. If the loads exceed this level, the controller 49 automatically stops movement of the abutment assembly 36 to thereby limit any potential damage. In another embodiment, the controller 49 automatically triggers an alarm to notify operators of the excessive loading.

In one embodiment, the load sensor 76 is operatively connected to the second abutment member 40 such that the load sensor 76 can detect force and/or torque on the second abutment member 40. As such, the user can more accurately monitor the loading occurring while the vehicle door 22 is opened and closed, and overloading the vehicle door 22 is unlikely.

Also, in one embodiment, the vehicle door 22 may include a clip or other device (not shown) that positively retains the door 22 in the closed position. When closing the door 22, the door 22 will eventually press against the clip, and the clip will resist further movement of the door 22 toward the closed position. However, the resistance force from the clip can be overcome, and the door 22 will fully close and be retained by the clip or latch. Thus, as the abutment assembly 36 moves the door 22 from the open position toward the closed position, loading will increase on the abutment assembly 36 due to the resistance of the clip. In one embodiment, the abutment assembly 36 overcomes the resistance of the clip and moves the door 22 a predetermined distance based on the type of clip to fully close the door 22. In another embodiment, the abutment assembly 36 overcomes the resistance of the clip and moves the door 22 until the load sensor 76 detects another load increase caused by the door 22 pressing against the vehicle body 20. As such, the load sensor 76 provides more precise indication of the position of the vehicle door 22 relative to the vehicle body 20.

It should be appreciated that the positioning device 10 has a high degree of control of the opening and closing of the vehicle door 22 because the inner panel 50 lies between the first and second abutment members 38, 40 during opening and closing. In other words, the first abutment member 38 will inhibit the vehicle door 22 from moving more than the desired distance toward the vehicle body 20, and the second abutment member 40 will inhibit the vehicle door 22 from moving more than the desired distance away from the vehicle body 20. As such, the vehicle 18, the positioning device 10, the robotic apparatus 12, and/or other external structures are unlikely to be damaged due to inadvertent movement of the vehicle door 22.

Turning now to FIG. 4, another embodiment of the positioning device is generally indicated at 110 where like numerals increased by 100 are used to designate like structure with respect to the embodiment illustrated in FIGS. 1 through 3. The positioning device 110 includes an abutment assembly 136 and an actuator assembly 148. The abutment assembly 136 includes a first abutment member 138 and a second abutment member 140, which are each mounted to a mount member 142. In the embodiment shown, the first and second abutment members 138, 140 are approximately the same length. The actuator assembly 148 is operable to move the abutment assembly 136 between the locating position and the inserted position similar to the embodiment of FIGS. 1 through 3. The actuator assembly 148 is also operable to open and close the vehicle door as described above.

Furthermore, in the embodiment shown, the actuator assembly 148 is adapted for moving at least one of the first abutment member 138 and the second abutment member 140 relative to the other of the first abutment member 138 and the second abutment member 140. For instance, in the embodiment shown, the actuator assembly 148 is operable to move the second abutment member 140 toward and away from the first abutment member 138 for gripping and releasing the vehicle door. Such movement of the second abutment member 140 can provide greater control of the movement of the vehicle door. As shown in FIG. 5, the actuator assembly 148 is further operable to move the second abutment member 140 such that the axis of the second abutment member 140 is disposed at a positive angle relative to the axis of the first abutment member 138. In the embodiment shown, the angle between the axes of the first and second abutment members 138, 140 can vary between zero degrees (0°) and ninety degrees (90°).

As such, the second abutment member 140 can be flipped up and away from the vehicle door as the first abutment member 138 locates the vehicle door. Once the door is located, the second abutment member 140 can be flipped down such that the axes of the first and second abutment members 138, 140 are parallel, and in so doing, the second abutment member 140 can inserted into the vehicle door.

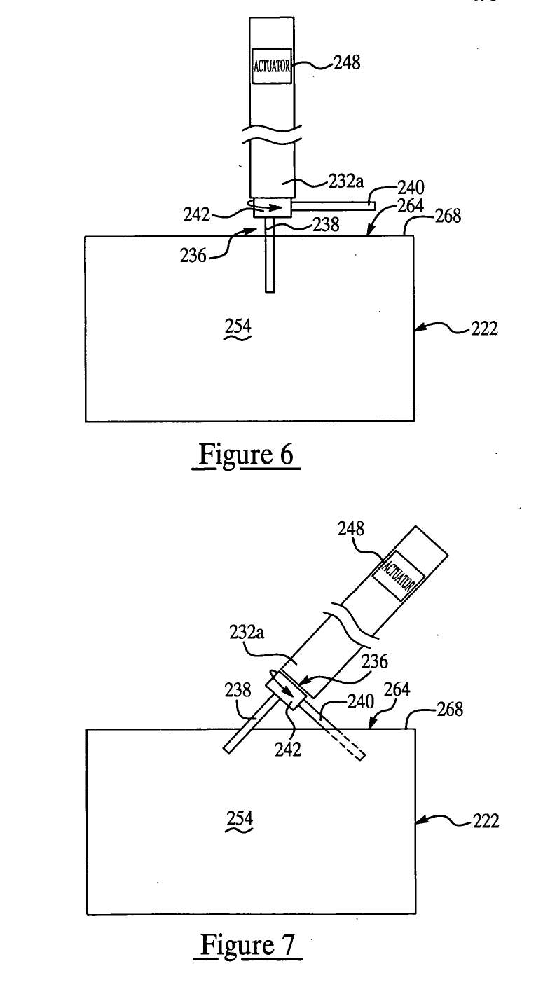

Turning now to FIGS. 6 and 7, another embodiment of the positioning device is generally indicated at 210 where like numerals increased by 200 are used to designate like structure with respect to the embodiment illustrated in FIGS. 1 through 3. In the embodiment shown, the axis of the first abutment member 238 is disposed at a positive angle relative to the axis of the second abutment member 240. More specifically, the first and second abutment members 238 are fixed to the mount member 242 at a positive angle (e.g. approximately. 90°) relative to each other. Also, the actuator assembly 248 is operable to rotationally move the abutment assembly 236 between the locating position (FIG. 6) and the inserted position (FIG. 7). In one embodiment, to achieve the rotational motion, the actuator assembly 248 rotates the robot arm 232a to rotate the abutment assembly 236 about a point. In one embodiment, the actuator assembly 248 additionally rotates the mount member 242 relative to the robot arm 232a.

In operation, the actuator assembly 248 moves the first abutment member 238 adjacent the exterior surface 254 of the vehicle door 222 to thereby “locate” the vehicle door 222. Once the door 222 has been located, the actuator assembly 248 rotates the abutment assembly 236 to move the second abutment member 240 through the window slot 268 into the interior space 264 of the vehicle door 222. Those having ordinary skill in the art will appreciate that the rotational movement of the abutment assembly 236 may be more efficient than linear movement of the abutment assembly in some instances.

In summary, the positioning device 10, 110, 210 of the present invention can be used to position a moveable portion 21 of a workpiece 16 with improved control. Also, the positioning device 10, 110, 210 accommodates for any variation in the position of the workpiece 16 relative to the positioning device 10, 110, 210 because the moveable portion 21 is located by the positioning device 10, 110, 210 before movement. Furthermore, the positioning device 10, 110, 210 exerts relatively low loads on the moveable portion 21 of the workpiece 16 such that damage to the workpiece 16, the positioning device 10, 110, 210 and/or the robotic apparatus 12 is unlikely to occur. In addition, the positioning device 10, 110 is unlikely to deposit foreign materials on the workpiece 16.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A positioning device for a workpiece that has a body and a portion that is movably mounted to the body, wherein the portion has an exterior surface and also defines an exterior and interior space, the positioning device comprising:
an abutment assembly having a first abutment member and a second abutment member; and
an actuator assembly adapted for moving said abutment assembly between a locating position, in which said first abutment member is disposed adjacent the exterior surface while said second abutment member is disposed in the exterior space defined by the portion of the workpiece, and an inserted position, in which said second abutment member is disposed in the interior space defined by the portion of the workpiece while said first abutment member is disposed in the exterior space defined by the portion of the workpiece, and wherein said actuator assembly is further adapted to move the portion relative to the body due to abutment between the portion of the workpiece and at least one of said first abutment member and said second abutment member.

2. The positioning device of claim 1, further comprising at least one sensor operatively mounted to at least one of said first abutment member and said second abutment member, said at least one sensor adapted for detecting distance between the portion of the workpiece and at least one of said first abutment member and said second abutment member.

3. The positioning device of claim 2, wherein said sensor is a contact sensor adapted for detecting abutment between the portion of the workpiece and said one of said first abutment member and said second abutment member.

4. The positioning device of claim 2, wherein each of said first abutment member and said second abutment member has at least one of said sensors operably mounted thereto.

5. The positioning device of claim 1, wherein said first abutment member is axially longer than said second abutment member.

6. The positioning device of claim 1, wherein first abutment member includes a terminal end and said second abutment member includes a terminal end, wherein said first abutment member and said second abutment member are each mounted to a mount member, and wherein said terminal end of said first abutment member is disposed further away from said mount than said terminal end of said second abutment member.

7. The positioning device of claim 1, wherein the portion of the workpiece includes an inner panel having an exterior surface, wherein the portion of the workpiece further includes an outer panel, wherein the inner panel is closer to the body of the workpiece than the outer panel, and wherein said first abutment member abuts against the exterior surface of the inner panel when in the locating position.

8. The positioning device of claim 1, wherein said actuator assembly is further adapted for moving at least one of said first abutment member and said second abutment member relative to the other of said first abutment member and said second abutment member.

9. The positioning device of claim 8, wherein said actuator assembly can move at least one of said first abutment member and said second abutment member relative to the other for a gripping and releasing the portion.

10. The positioning device of claim 8, wherein said actuator assembly can move at least one of said first abutment member and said second abutment member relative to the other such that an axis of said second abutment member is disposed at a positive angle relative to an axis of said first abutment member.

11. The positioning device of claim 8, wherein an axis of said first abutment member is disposed at a positive angle relative to an axis of said second abutment member, and wherein said actuator assembly is adapted to rotationally move said abutment assembly between the locating position and the inserted position.

12. The positioning device of claim 1, further comprising at least one load sensor operable to detect a load on said abutment assembly.

13. The positioning device of claim 12, wherein the load sensor is operatively connected to the second abutment member to thereby detect a load on the second abutment member.

14. A method of positioning a movably mounted portion of a workpiece relative to a body of the workpiece, wherein the portion of the workpiece has an exterior surface, and wherein the portion of the workpiece defines an exterior and an interior space, said method comprising the steps of:
locating an abutment assembly having a first abutment member and a second abutment member relative to the portion of the workpiece by moving the first abutment member adjacent to the exterior surface of the portion of the workpiece while the second abutment member is disposed in the exterior space defined by the portion of the workpiece;
inserting the second abutment member into the interior space defined by the portion of the workpiece while the first abutment member is disposed in the exterior space defined by the portion of the workpiece; and
moving at least one of the first abutment member and the second abutment member into abutting contact with the portion of the workpiece to thereby move the portion relative to the body of the workpiece.

15. The method of claim 14, wherein the portion of the workpiece includes an inner panel having an exterior surface, wherein the portion of the workpiece further includes an outer panel, wherein the inner panel is closer to the body of the workpiece than the outer panel, and wherein said step of locating said abutment assembly comprises moving the first abutment member away from the body of the workpiece and into abutting contact with the exterior surface of the inner panel of the portion of the workpiece.

16. The method of claim 14, wherein the portion of the workpiece includes an inner panel and an outer panel, wherein the interior space is defined between the inner panel and the outer panel, and wherein said step of inserting the second abutment member comprises inserting the second abutment member between the inner panel and the outer panel.

17. The method of claim 14, wherein said step of moving at least one of the first abutment member and the second abutment member into abutting contact with the portion of the workpiece comprises moving the abutment assembly away from the body of the workpiece to thereby move the portion away from the body.

18. The method of claim 14, wherein said step of moving at least one of the first abutment member and the second abutment member into abutting contact with the portion of the workpiece comprises moving the abutment assembly toward the body of the workpiece to thereby move the portion toward the body.

19. The method of claim 14, wherein at least one of the first abutment member and the second abutment member has a sensor operatively mounted thereto, said method further comprising the step of detecting distance between the portion of the workpiece and at least one of the first abutment member and the second abutment member via the sensor.

20. The method of claim 14, further comprising the step of moving at least one of the first abutment member and the second abutment member relative to the other of the first abutment member and the second abutment member after said step of locating the abutment assembly and before said step of inserting the second abutment member.

21. The method of claim 20, wherein said step of moving at least one of the first abutment member and the second abutment member relative to the other occurs such that an axis of said second abutment member is disposed at a positive angle relative to an axis of said first abutment member.

22. A positioning device for positioning a vehicle door with respect to a vehicle body, wherein the vehicle door has a plurality of panels that define an exterior surface and that are disposed at a distance so as to define interior space and a window slot that is open to the interior space, the positioning device comprising:
an abutment assembly having a first abutment member and a second abutment member; and
an actuator assembly adapted for moving said abutment assembly between a locating position, in which said first abutment member is disposed adjacent the exterior surface while said second abutment member is disposed in the exterior space defined by the vehicle door, and an inserted position, in which said second abutment member extends through the window slot and is disposed in the interior space defined by the vehicle door while said first abutment member is disposed in the exterior space defined by the vehicle door, and wherein said actuator assembly is further adapted to move the vehicle door relative to the vehicle body due to abutment between the vehicle door and at least one of said first abutment member and said second abutment member.
